(19) United States
(12) Patent Application Publication
(10) Pub. No.: US 2006/0152638 A1
(43) Pub. Date: Jul. 13, 2006

(54) Liquid crystal device for birefringence compensation, and optical pickup and optical recording and/or reproducing apparatus that employ the same

(75) Inventors: Jong-chul Choi, Suwon-si (KR); Hee-Kyung Kim, Anyang-si (KR); Tae-Kyung Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/327,394

(22) Filed: Jan. 9, 2006

(30) Foreign Application Priority Data
Jan. 10, 2005 (KR) 2005-2048

(51) Int. Cl. G02F 1/13

(52) U.S. Cl. 349/2

(57) ABSTRACT

A liquid crystal device for birefringence compensation and an optical pickup and an optical recording and/or reproducing apparatus that employ the liquid crystal device as a birefringence compensation device are provided. The liquid crystal device includes a liquid crystal layer in which liquid crystal is vertically aligned when an electric field is not applied thereto, and is radially aligned in axial symmetry when the electric field is applied thereto. As a result, phase variation distribution corresponding to birefringence distribution occurring on an optical information storage medium is formed and a phase variation is adjusted according to the magnitude of the applied electric field.

### CROSS-REFERENCE TO RELATED APPLICATIONS

This application claims all benefits accruing under 35 U.S.C. §119 from Korean Patent Application No. 10-2005-0002048, filed on Jan. 10, 2005, in the Korean Intellectual Property Office, the disclosure of which is incorporated by reference herein.

### BACKGROUND OF THE INVENTION

1. Field of the Invention

The present invention relates to a an optical recording and/or reproducing apparatus, and more particularly, to a liquid crystal device for birefringence compensation in an optical information storage medium, and an optical pickup and an optical recording and/or reproducing apparatus that employ the liquid crystal device.

2. Related Art

In general, a substrate of an optical information storage medium such as an optical disc in which information is recorded onto and/or reproduced from using light is made using polycarbonate. Such a polycarbonate substrate has in-plane birefringence and vertical birefringence. The vertical birefringence affects the reproducing/recording performance more than the in-phase birefringence. When light is focused on an optical information storage medium and a light spot is formed on an information surface, peripheral light rays are focused on the information surface within the optical information storage medium at a greater angle than central light rays. As the angle becomes greater, the reproducing/recording performance becomes more affected by the vertical birefringence than by the in-phase birefringence.

FIG. 1 illustrates the degrees of influence of vertical birefringence according to positions of incident light ray when the light is focused on an optical disc 1 and forms a light spot on the optical disc 1. Referring to FIG. 1, a solid line with bidirectional arrow heads indicates a polarization direction of the light and a dotted line with bidirectional arrow heads indicates the degree of influence of vertical birefringence exerted on each light beam. The degree of the influence of the vertical birefringence corresponds to a component projected in a direction of vertical birefringence of polarized light.

As shown in FIG. 1, since peripheral light rays form a greater angle than central light rays, the peripheral light rays are more influenced by vertical birefringence than the central light rays. Due to the influence of the vertical birefringence, the size of a focused light spot becomes greater and light intensity per unit area decreases. The increase in the size of a focused light spot and the change in the light intensity affect the quality of signal recording/reproducing operation. Accordingly, birefringence affecting the signal recording/reproducing needs to be optically compensated so that signal recording and reproducing can be efficiently performed.

For birefringence compensation, a conventional technique of manufacturing a wave plate patterned such that a plurality of phase areas having different phases are present at different radii in a radial direction has been suggested. However, this wave plate has a fixed phase size. As a result, it is difficult to compensate for the amount of birefringence which is different according to an optical information storage medium.

### SUMMARY OF THE INVENTION

Various aspects and example embodiments of the present invention advantageously provide a liquid crystal device for dynamically compensating for birefringence which is different according to optical information storage medium, and an optical pickup and an optical recording and/or reproducing apparatus which use the liquid crystal device.

Additional aspects and/or advantages of the invention will be set forth in part in the description which follows and, in part, will be obvious from the description, or may be learned by practice of the invention.

In accordance with an aspect of the present invention, there is provided a liquid crystal device for birefringence compensation, comprising a liquid crystal layer in which liquid crystal is vertically aligned when an electric field is not applied thereto, and is radially aligned in axial symmetry when the electric field is applied thereto, wherein a phase variation distribution corresponding to a birefringence distribution occurring on an optical information storage medium is formed and a phase variation is adjusted according to the magnitude of the applied electric field.

The liquid crystal device may further include a substrate having on an inside thereof an axial symmetric thickness variation profile corresponding to the birefringence distribution occurring on the optical information storage medium. The thickness variation profile of the substrate may have a step structure. The substrate may be made of a material having the same refractive index as an ordinary refractive index of the liquid crystal or having an index-matchable refractive index similar to the ordinary refractive index of the liquid crystal.

The liquid crystal device may further include an electrode patterned to supply different voltages to different portions of the liquid crystal layer in correspondence with the birefringence distribution occurring on the optical information storage medium, and an alignment film that is formed to vertically align the liquid crystal and is radially rubbed in axial symmetry. The alignment film may be made using one of polyimide for vertical alignment and SiO deposition. The liquid crystal may have a negative dielectric anisotropic property.

In accordance with another aspect of the present invention, there is provided an optical pickup comprising a light source; an objective lens arranged to focus light emitted from the light source on an optical information storage medium to form a light spot; a photo-detector arranged to receive light reflected from the optical information storage medium and detect at least one of an information signal and an error signal; and a birefringence compensation device for compensating for birefringence on the optical information storage medium, wherein the birefringence compensation device comprises a liquid crystal device having at least one of the above-described characteristics.

The optical pickup may further include a wave plate for converting polarization of the light incident from the light source, wherein the birefringence compensation device may be positioned between the wave plate and the objective lens.

The wave plate may be a quarter-wave plate with respect to a wavelength of the light emitted from the light source so that effective light incident onto the birefringence compensation device is circularly polarized light.

In accordance with still another aspect of the present invention, there is provided an optical recording and/or reproducing apparatus comprising an optical pickup which is installed to move in a radial direction of an optical information storage medium for reproducing information from and/or recording information onto the optical information storage medium; and a control unit arranged to control operation of the optical pickup, wherein the optical pickup has at least one among the above-described characteristics of the optical pickup.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates the degrees of influence of vertical birefringence according to positions of incident light when the light is focused on an optical disc and forms a light spot on the optical disc;

FIG. 2 is a diagram of an example optical pickup using a liquid crystal device as a birefringence compensation device, according to an embodiment of the present invention;

FIGS. 3A and 3B illustrate example arrangements of liquid crystal molecules in a liquid crystal layer of a liquid crystal device according to an embodiment of the present invention, when an electric field is off and when the electric field is on, respectively;

FIGS. 4A and 4B are plan views of the example arrangements shown in FIGS. 3A and 3B, respectively;

FIG. 5 is a diagram of an example radial rubbing treatment in axial symmetry;

FIG. 6 is a cross section of a liquid crystal device according to another embodiment of the present invention;

FIG. 7 is a plan view of a pattern of an electrode shown in FIG. 6; and

FIG. 8 is a diagram of an example optical recording and/or reproducing apparatus using an optical pickup according to an embodiment of the present invention.

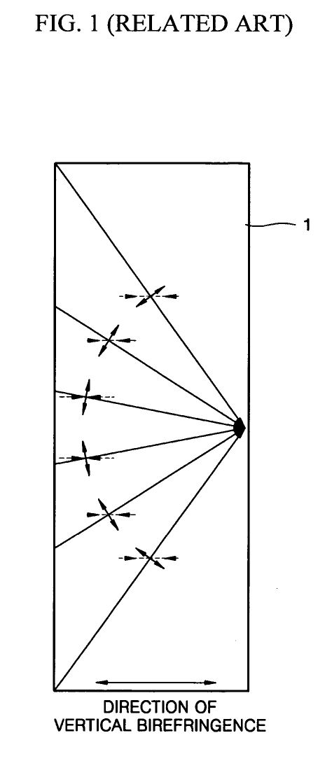

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

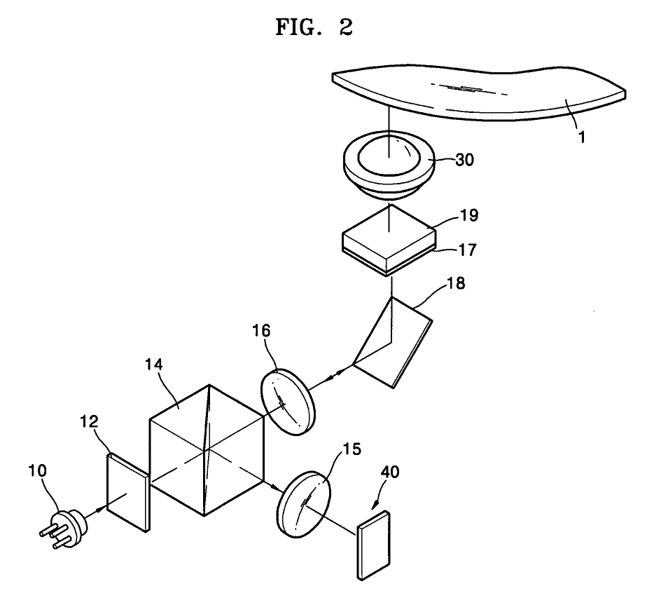

FIG. 2 is a diagram of an example optical pickup using a liquid crystal device as a birefringence compensation device, according to an embodiment of the present invention. As shown in FIG. 2, the optical pickup includes a light source 10; an objective lens 30 arranged to focus light emitted from the light source 10 on an optical information storage medium, e.g., an optical disc 1, to form a light spot; a birefringence compensation device 19 arranged to compensate for birefringence on the optical disc 1; and a photo-detector 40 arranged to receive light reflected from the optical disc 1 and detect an information signal and/or an error signal.

In addition, the optical pickup may further include a wave plate 17 for converting effective light, which is emitted from the light source 10 and advances to the birefringence compensation device 19, into circularly polarized light. Moreover, the optical pickup may further include a polarization-dependent optical path converter, e.g., a polarizing beam splitter 14, which converts the proceeding path of incident light according to polarization in order to satisfy high efficiency demand in an optical recording system.

Reference numeral 12 denotes a grating which splits light emitted from the light source 10 so that a tracking error signal is detected using a three-beam method or a differential push-pull method. Reference numeral 16 denotes a collimating lens which converts diverging light emitted from the light source 10 into parallel light and directs the parallel light to the objective lens 30. Reference numeral 15 denotes an astigmatism lens which generates astigmatism so that a focus error signal is detected using an astigmatism method. Reference numeral 18 denotes a reflecting mirror which shifts the proceeding path of light.

The light source 10 may emit light in a blue wavelength range, i.e., 405 nm wavelength light. The objective lens 30 may have a high numerical aperture (NA) of about 0.65 satisfying a high-density optical disc, e.g., a high definition digital versatile disc (HD DVD) standard.

As described in connection with FIG. 2, when the light source 10 emits light in the blue wavelength range and the objective lens 30 has a numerical aperture (NA) of 0.65, the optical pickup according to an embodiment of the present invention can perform recording and/or reproducing on a high-density optical disc and particularly on an HD DVD.

The wavelength of the light source 10 and the numerical aperture (NA) of the objective lens 30 may vary diversely. In addition, the optical structure of the optical pickup may also vary diversely according to embodiments of the present invention. For example, to enable an optical pickup according to the present invention to perform recording and/or reproducing on a DVD that has multiple recording layers on one side, the light source 10 may be designed to emit light in a red wavelength range, e.g., 650 nm wavelength light, suitable for the DVD and the objective lens 30 may be designed to have a numerical aperture (NA), for example, of 0.6 or 0.65 suitable for the DVD.

In addition, to enable an optical pickup according to the present invention to be compatible with a Blu-ray disc (BD), an HD DVD, and a DVD, the light source 10 may be implemented as a light source module that emits light of multiple wavelengths, e.g., light of a blue wavelength suitable for a high-density optical disc and light of a red wavelength suitable for a DVD. The objective lens 30 may be designed to have an effective numerical aperture (NA) suitable for a BD standard and a DVD standard. Alternatively, a separate member that adjusts the effective numerical aperture (NA) may be further provided.

Moreover, according to an embodiment of the present invention, an optical pickup has the optical structure shown in FIG. 2 to perform recording and/or reproducing on a high-density optical disc, and further has an additional optical structure to recording and/or reproducing on a DVD and/or a compact disc (CD). Alternatively, the light source 10 and the objective lens 30 may be designed to enable an optical pickup to be compatible with both of a DVD and a CD and to perform recording and/or reproducing thereon.

Meanwhile, the polarization-dependent optical path converter directs light emitted from the light source 10 to the objective lens 30 and directs light reflected from the optical disc 1 to the photo-detector 40. As shown in FIG. 2, a polarizing beam splitter 14 that selectively transmits or reflects light according to polarization is used as the polarization-dependent optical path converter. Alternatively, a polarization holographic device that transmits light, which is emitted from the light source 10 and polarized in one direction, and performs +1 or −1 order diffraction of light, which is reflected from the optical disc 1 and polarized in other directions, may be used as the polarization-dependent optical path converter.

The wave plate 17 may be a quarter-wave plate with respect to the wavelength of light emitted from the light source 10.

Linearly polarized light, e.g., p-polarized light, incident from the light source 10 to the polarizing beam splitter 14 passes through a mirror surface of the polarizing beam splitter 14 and is converted by the wave plate 17 into circularly polarized light, e.g., right-circularly polarized light, which advances to the optical disc 1. Then, the circularly polarized light is reflected from the optical disc 1 and converted into different circularly polarized light, e.g., left-circularly polarized light. The different circularly polarized light is converted by the wave plate 17 into different linearly polarized light, e.g., s-polarized light. The different linearly polarized light is reflected from the mirror surface of the polarizing beam splitter 14 and directed to the photo-detector 40.

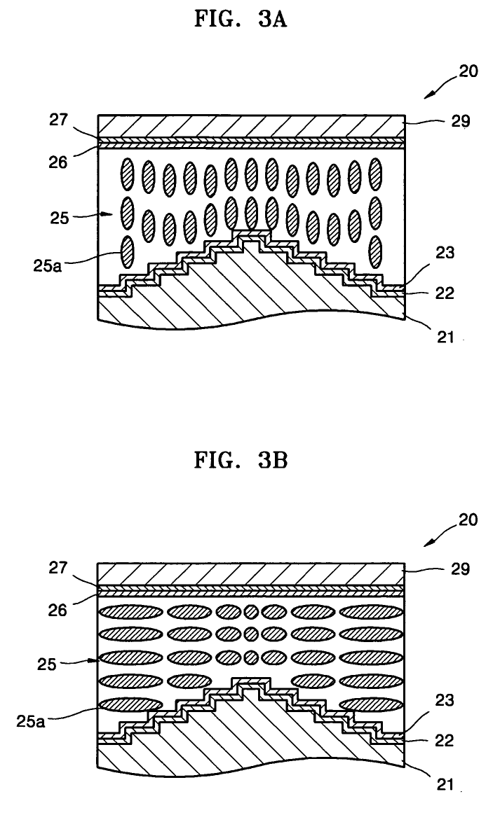

The birefringence compensation device 19 compensates for birefringence on the optical disc 1, and particularly, vertical birefringence appearing in the thickness direction of the optical disc 1. The birefringence compensation device 19 may be implemented by a liquid crystal device 20 or 20′ for birefringence compensation according to an embodiment of the present invention, which will be described with reference to FIGS. 3A through 7 herein below.

The liquid crystal device 20 or 20′ is designed such that liquid crystal molecules in a liquid crystal layer are vertically aligned, when an electric field is not applied, and are radially aligned in axial symmetry, when the electric field is applied. The liquid crystal device 20 or 20′ is designed to generate phase variation distribution corresponding to birefringence distribution on the optical disc 1 and can adjust the phase variation distribution according to the intensity of the electric field applied to the liquid crystal layer. When the liquid crystal device 20 or 20′ is used, birefringence changing according to of the optical disc 1 can be actively compensated for.

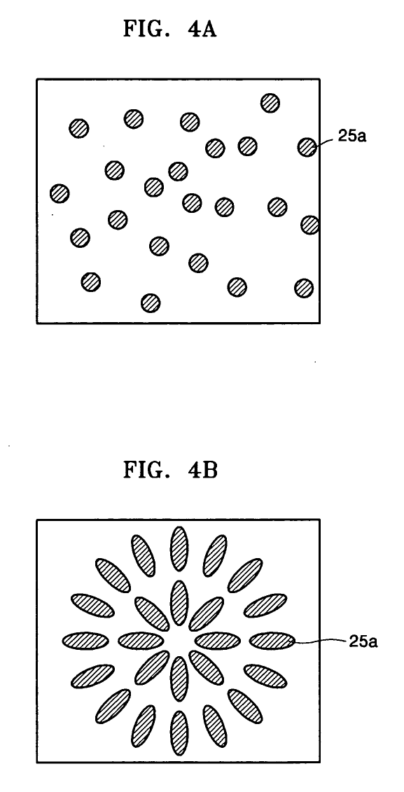

Turning now to FIGS. 3A and 3B, cross sections of an example liquid crystal device 20 according to an embodiment of the present invention are shown. Specifically, FIG. 3A shows an example arrangement of liquid crystal molecules in a liquid crystal layer between a pair of substrates, when an electric field is turned off. FIG. 3B shows an example arrangement of the liquid crystal molecules in the liquid crystal layer between a pair of substrates, when the electric field is turned on. FIGS. 4A and 4B are plan views of the example arrangements shown in FIGS. 3A and 3B, respectively.

Referring to FIGS. 3A through 4B, the liquid crystal device 20 uses a substrate having an axial symmetric thickness variation profile that corresponds to birefringence distribution appearing on the optical disc 1 (FIG. 2), and preferably to average birefringence distribution appearing on a particular format of optical disc 1, in inner side of the substrate. Such substrate having the axial symmetric thickness variation profile can be used for birefringence compensation because the degrees of influence of vertical birefringence according to positions of light focused on and forming a light spot on the optical disc 1 appear in axial symmetry.

As shown in FIGS. 3A and 3B, a thickness variation profile of the substrate may have a step structure in axial symmetry. Since birefringence appearing while a light spot is focused on the optical disc 1 has a form of R², i.e., a form proportional to the second power of a radius, when the substrate is made in an elliptical shape or a parabolic step structure, birefringence appearing on the optical disc 1 can be compensated.

When such substrate is used, a phase variation distribution capable of compensating for reference average birefringence distribution on the optical disc 1 can be formed. When an optical disc 1 having different birefringence distribution from the reference average birefringence distribution is used, the phase variation distribution is adjusted by adjusting a voltage supplied to the liquid crystal layer of the liquid crystal device 20, thereby compensating for birefringence.

Specifically, referring to FIGS. 3A and 3B, the liquid crystal device 20 includes first and second substrates 21 and 29; first and second electrodes 22 and 27 formed on the insides of the first and second substrates 21 and 29, respectively; a liquid crystal layer 25 filled between the first and second substrates 21 and 29; and first and second alignment films 23 and 26 positioned between the liquid crystal layer 25 and the first and second electrodes 22 and 27, respectively.

The first substrate 21 may have an axial symmetric thickness variation profile that corresponds to average birefringence distribution on a particular format of optical disc 1. The second substrate 29 may be flat. For example, axial symmetric distribution, e.g., axial symmetric step structure, of thickness may be formed on the inside of the first substrate 21 in the same form as average birefringence distribution to be compensated.

Meanwhile, the first electrode 22 and the first alignment film 23 are formed on the inside of the first substrate 21. The second electrode 27 and the second alignment film 26 are formed on the inside of the second substrate 29.

The first substrate 21 may be made using a material having the same refractive index as an ordinary refractive index of a liquid crystal in the liquid crystal layer 25, or an index-matchable refractive index similar to the ordinary refractive index thereof.

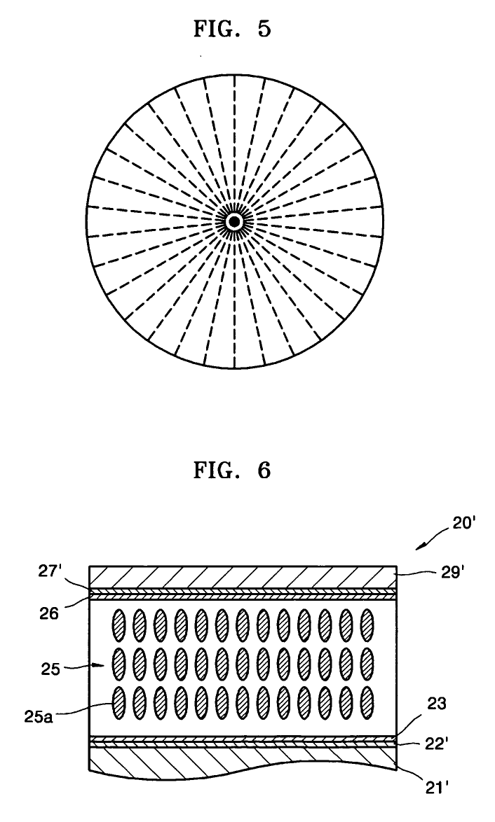

When an electric field is not applied to the liquid crystal layer 25, the liquid crystal molecules are vertically aligned as shown in FIGS. 3A and 4A. When the electric field is applied to the liquid crystal layer 25, the liquid crystal molecules are radially aligned in axial symmetry as shown in FIGS. 3A and 4A. For this alignment, the first and second alignment films 23 and 26 are formed to vertically align the liquid crystal and are rubbed in axial symmetry as shown in FIG. 5, which shows an example of a radial rubbing treatment in axial symmetry.

The first and second alignment films 23 and 26 may be made using polyimide for vertical alignment or made using SiO deposition. The SiO deposition is a process of depositing a material for an alignment film on a substrate such that the molecules of the material are arranged on the substrate at a particular angle.

After the first and second alignment films 23 and 26 are formed to be vertical alignment films, a radial rubbing treatment is performed in axial symmetry on the first and second alignment films 23 and 26. As a result, liquid crystal directors 25a are vertically aligned, as shown in FIGS. 3A and 4A, when an electric field is not applied to the liquid crystal layer 25. However, when the electric field is applied to the liquid crystal layer 25, the liquid crystal directors 25a are aligned to be parallel with the first and second substrates 21 and 29 in axial symmetry, as shown in FIGS. 3B and 4B.

To obtain such liquid crystal alignment, the liquid crystal layer 25 may be made using a negative dielectric anisotropic liquid crystal exclusively used for vertical alignment, for example, a negative dielectric anisotropic nematic liquid crystal.

The negative dielectric anisotropic liquid crystal moves in a direction perpendicular to an applied electric field. Accordingly, when the electric field is applied, the liquid crystal lies parallel with a substrate. Here, if an alignment film has not been subjected to any pre-treatment, the liquid crystal lies randomly. However, if radial rubbing treatment has been rapidly done in advance, the liquid crystal lies in the rubbed direction, i.e., in radial alignment. Therefore, when the electric field is applied to the liquid crystal layer 25, desired phase variation distribution suitable for birefringence compensation can be obtained.

For the liquid crystal layer 25, a high anisotropic liquid crystal for a vertical alignment mode, such as MAT-03-427 (Δε=−3.9, nₑ=1.6733, nₒ=1.5024, Δn=0.1709) made by Merck, may be used. Here, Δε denotes a dielectric anisotropic property, nₑ denotes an extra ordinary refractive index, nₒ denotes an ordinary refractive index, and Δn denotes a difference between the extra ordinary refractive index and the ordinary refractive index.

In this situation, the first substrate 21 may be made using a material, e.g., glass, having the same refractive index as the ordinary refractive index of the liquid crystal like n_{g}=nₒ=1.5 and having a minimum absorption rate in a wavelength from about 400 to 418 nm. The first substrate 21 may be manufactured by shape processing a glass material to have a thickness variation profile corresponding to pre-calculated average refractive index distribution on a optical disc of a predetermined format. A material for the first substrate 21 may be glass having the same ordinary refractive index as the liquid crystal or having a similar refractive index to the ordinary refractive index of the liquid crystal within an index matchable range. The second substrate 29 may be made using the same material of the first substrate 21. However, unlike the first substrate 21, the second substrate 29 does not need to be shape-processed.

The first and second electrodes 22 and 27 are formed by coating a selected glass material with a transparent electrode such as an indium tin oxide (ITO) electrode.

Alignment of liquid crystal molecules may be achieved by spin coating using normal homogeneous type polyimide and rubbing the polyimide. Accordingly, the first and second alignment films 23 and 26 may be formed by spin coating using a material, such as a vertical aligning agent JALS1 H659 made by JSR, as a polyimide aligning agent or by SiO deposition.

In manufacturing the liquid crystal device 20, each of the first and second substrates 21 and 29 may be shape-processed such that a combination of the thickness variation profiles of the respective first and second substrates 21 and 29 corresponds to desired cell gap distribution.

The liquid crystal device 20 according to the above-described embodiment of the present invention has a structure in which birefringence, particularly vertical birefringence, different according to optical disc 1 is compensated for by using a thickness variation profile implemented as the inflection of a substrate and by adjusting voltage supplied to a liquid crystal. Here, liquid crystal molecules are vertically aligned when an electric field is not applied, and are radially aligned in a horizontal direction when the electric field is applied.

The thickness variation profile implemented as the inflection of the substrate is formed corresponding to average birefringence distribution appearing a particular format of an optical disc 1. With respect to an optical disc 1 having different birefringence distribution from the average birefringence distribution, voltage supplied to the liquid crystal is adjusted such that entire phase variation distribution in the liquid crystal device 20 becomes to coincide with the different birefringence distribution.

When a predetermined voltage (V) is supplied to the first and second electrodes 22 and 27 to make phase variation distribution corresponding to the average birefringence distribution of the particular format of an optical disc 1 between the first and second substrates 21 and 29, magnitude distribution of an electric field (E=V/d) applied to the liquid crystal layer 25 becomes to correspond to the average birefringence distribution. Here, the magnitude distribution of the electric field corresponding to the average birefringence distribution can be obtained because the first substrate 21 has the thickness variation profile that can compensate for the average birefringence distribution, and thus a distance (d) between the first and second electrodes 22 and 27 changes in correspondence with the thickness variation profile of the first substrate 21 and because the magnitude of the electric field is in inverse proportion to the distance (d) between the first and second electrodes 22 and 27.

Since the arrangement of the liquid crystal molecules changes corresponding to the magnitude distribution of the electric field, average phase variation distribution corresponding to the average birefringence distribution can be given in incident light so that birefringence can also be compensated. When an optical disc 1 has different birefringence distribution from the average birefringence distribution, a voltage supplied to the first and second electrodes 22 and 27 is adjusted so that the magnitude distribution of the electric field applied to the liquid crystal layer 25 changes, thereby changing the arrangement of the liquid crystal molecules. As a result, phase variation distribution corresponding to the different birefringence distribution on the optical disc 1 is applied to the incident light and birefringence on the optical disc 1 is compensated. In other words, the liquid crystal device 20 can actively compensate for birefringence changing according optical disc 1.

Meanwhile, in the liquid crystal device 20, the first and second electrodes 22 and 27 may be formed by entirely coating the first and second substrates 21 and 29 with a transparent electrode, e.g., an ITO electrode. This is because birefringence compensation is achieved mostly by the thickness variation profile of at least one of the first and second substrates 21 and 29 and just slightly by the liquid crystal layer 25.

In the liquid crystal device 20, since the first and second electrodes 22 and 27 can be formed using a simple coating process in the liquid crystal device 20, ITO electrode patterning and metal electrode deposition are not required. Accordingly, electrode manufacturing processes is remarkably simplified and manufacturing cost is reduced. In addition, reduction of transmittance and compensation effect due to the separate formation of an ITO electrode and the addition of a metal electrode can be prevented. In addition, since only two lead lines are needed for driving, a driving and wiring method is much simplified. Therefore, the liquid crystal device 20 according to the above-described embodiment of the present invention can contribute to manufacturing of a compact, light-weight, and inexpensive optical pickup.

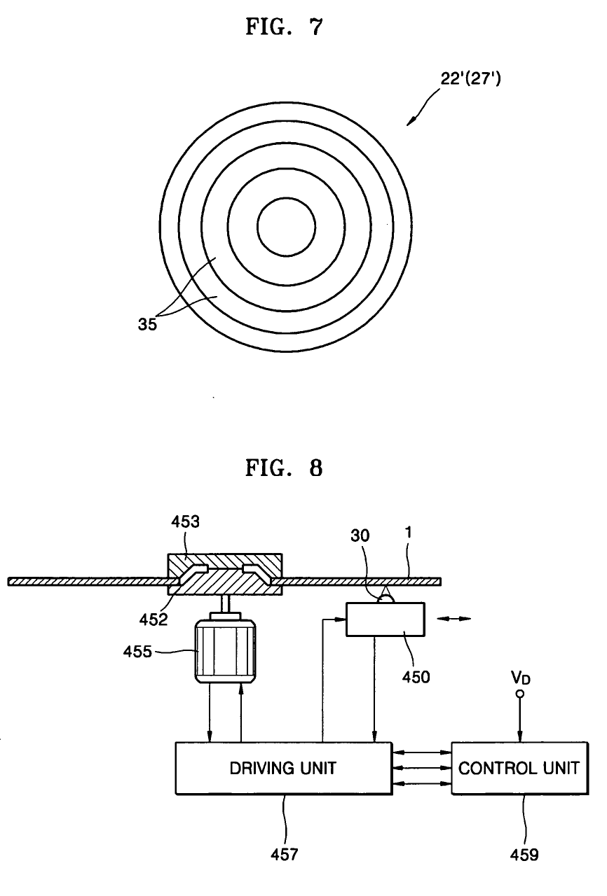

FIG. 6 is a cross section of a liquid crystal device 20′ according to another embodiment of the present invention. FIG. 7 is a plan view of a pattern of an electrode shown in FIG. 6. Here, a detailed description of elements denoted by the same reference numerals of the elements as described above will not be repeated herein.

As shown in FIGS. 6 and 7, the liquid crystal device 20′ used as the birefringence compensation device 19 (FIG. 2) in an optical pickup according to an embodiment of the present invention uses an electrode that is patterned to apply different electrode fields to different portions of the liquid crystal layer 25 in correspondence with the birefringence distribution appearing on the optical disc 1 (FIG. 2), instead of using the thickness variation profile corresponding to the inflection of a substrate. FIG. 6 shows a state in which an electric field is not applied to the liquid crystal layer 25. When the electric field is applied to the liquid crystal layer 25 in the liquid crystal device 20′, however, liquid crystal molecules are arranged as shown in FIGS. 3B and 4B.

Specifically, the liquid crystal device 20′ includes first and second substrates 21′ and 29′, and first and second electrodes 22′ and 27′. As shown in FIG. 6, both the first and second substrates 21′ and 29′ are flat. However, at least one of the first and second electrodes 22′ and 27′ has a pattern for obtaining phase variation distribution having an elliptical or a parabolic step structure corresponding to the birefringence distribution on the optical disc 1. For example, the first electrode 22′ may be patterned as shown in FIG. 7, and the second electrode 27′ may be homogeneously formed on the entire surface of the second substrate 29′.

The structure of the liquid crystal device 20′ is substantially the same as that of the liquid crystal device 20, with the exception that both of the first and second substrates 21′ and 29′ are flat, and at least one of the first and second electrodes 22′ and 27′ is patterned as shown in FIG. 7. Here, the first and second substrates 21′ and 29′ may be made using the same material as the first and second substrates 21 and 29, shown in FIGS. 3A and 3B. Similarly, the first and second electrodes 22′ and 27′ may be made using the same material as the first and second electrodes 22 and 27 shown in FIGS. 3A and 3B.

Referring to FIG. 7, the pattern of at least one of the first and second electrodes 22′ and 27′ includes a plurality of concentric annular electrode areas 35. The width of each annular electrode area 35 is determined based on the average birefringence distribution of the optical disc 1. Different voltages are supplied to the plurality of the annular electrode areas 35, respectively, so that the arrangement of liquid crystal molecules corresponding to the annular electrode areas 35 changes, thereby forming phase variation distribution corresponding to birefringence distribution on the optical disc 1. As a result, birefringence can be compensated. The reason why an electrode patterned with the plurality of the annular electrode areas 35 is used for birefringence compensation is because the degrees of influence of vertical birefringence at different positions of incident light, which is focused on the optical disc 1 and forms a light spot, is roughly in axial symmetry.

As an alternative of the pattern shown in FIG. 7, each of the annular electrode areas 35 formed on at least one of the first and second electrodes 22′ and 27′ may be divided into a plurality of sectors to form more elaborate phase variation distribution corresponding to the birefringence distribution on the optical disc 1.

The birefringence compensation device 19 implemented by the liquid crystal device 20 or 20′ may be positioned between the wave plate 17 and the objective lens 30 so that a phase difference is given to circularly polarized light. Here, with only one birefringence compensation device 19, polarization dependency can be overcome and birefringence compensation can be accomplished with respect to both of incoming and outgoing light.

FIG. 8 is a diagram of an example optical recording and/or reproducing apparatus using an optical pickup according to an embodiment of the present invention. Referring to FIG. 8, the optical recording and/or reproducing apparatus includes a spindle motor 455 for rotating an optical disc 1, i.e., an optical information storage medium; an optical pickup 450 which is installed to move in the radial direction of the optical disc 1 and reproduces information from and/or records information onto the optical disc 1; a driving unit 457 for driving the spindle motor 455 and the optical pickup 450; and a control unit 459 for controlling focus and tracking servo of the optical pickup 450. Reference numeral 452 denotes a turntable. Reference numeral 453 denotes a clamp for chucking. The optical pickup 450 has an optical configuration according to the above-described embodiment of the present invention.

Light reflected from the optical disc 1 is detected and converted into an electrical signal by a photo-detector provided in the optical pickup 450. The electrical signal is input to the control unit 459 via the driving unit 457. The driving unit 457 controls the rotation speed of the spindle motor 455, amplifies an input signal, and drives the optical pickup 450. The control unit 459 adjusts a focus servo command and a tracking servo command based on a signal received from the driving unit 457 and sends the commands to the driving unit 457 so that the focusing and tracking operations of the optical pickup 450 are accomplished.

When recording information onto and/or reproducing information from the optical disc 1, the optical recording and/or reproducing apparatus according to an embodiment shown in FIG. 8 compensates for birefringence of the optical disc 1 by supplying voltage to the birefringence compensation device 19 implemented by the liquid crystal device 20 or 20′ and forming phase variation distribution corresponding to birefringence distribution and particularly vertical birefringence distribution occurring on the optical disc 1. Accordingly, an increase in the size of a light spot and a decrease in light intensity per unit area due to birefringence can be prevented. As a result, the birefringence of the optical disc 1 does not affect signal recording and reproducing.

As described above, according to the present invention, birefringence varying according to a type of optical information storage medium can be actively compensated, and therefore, enlargement of a light spot and reduction of light intensity per unit area due to birefringence can be prevented. As a result, recording and reproducing can be efficiently performed.

While the present invention has been particularly shown and described with reference to exemplary embodiments thereof, it will be understood by those of ordinary skill in the art that various changes in form and details may be made therein without departing from the spirit and scope of the present invention. For example, any other arrangement of elements in an optical pickup may be utilized, as long as a liquid crystal device is utilized in the manner described in connection with FIG. 2, FIGS. 3A-3B, FIGS. 4A-4B, and FIG. 6. In addition, components of an optical recording and/or reproducing apparatus can also be configured differently as shown in FIG. 8. Accordingly, it is intended, therefore, that the present invention not be limited to the various example embodiments disclosed, but that the present invention includes all embodiments falling within the scope of the appended claims.

What is claimed is:

1. A liquid crystal device for birefringence compensation, comprising:
a pair of substrates; and
a liquid crystal layer formed between the substrates in which liquid crystal is vertically aligned when an electric field is not applied thereto, and is radially aligned in axial symmetry when the electric field is applied thereto,
wherein a phase variation distribution corresponding to a birefringence distribution occurring on an optical information storage medium is formed and a phase variation is adjusted according to the magnitude of an applied electric field.

2. The liquid crystal device as claimed in claim 1, wherein at least one of the substrates has on an inside thereof an axial symmetric thickness variation profile corresponding to the birefringence distribution occurring on the optical information storage medium.

3. The liquid crystal device as claimed in claim 2, wherein the thickness variation profile of the at least one of the substrates has a step structure.

4. The liquid crystal device as claimed in claim 2, wherein the at least one of the substrates is made of a material having the same refractive index as an ordinary refractive index of the liquid crystal, or having an index-matchable refractive index similar to the ordinary refractive index of the liquid crystal.

5. The liquid crystal device as claimed in claim 1, further comprising an electrode patterned to supply different voltages to different portions of the liquid crystal layer in correspondence with the birefringence distribution occurring on the optical information storage medium.

6. The liquid crystal device as claimed in claim 1, further comprising an alignment film that is formed to vertically align the liquid crystal, and is radially rubbed in axial symmetry.

7. The liquid crystal device as claimed in claim 6, wherein the alignment film is made using one of polyimide for vertical alignment and SiO deposition.

8. The liquid crystal device as claimed in claim 1, wherein the liquid crystal has a negative dielectric anisotropic property.

9. An optical pickup comprising:
a light source;
an objective lens arranged to focus light emitted from the light source on an optical information storage medium to form a light spot;
a photo-detector arranged to receive light reflected from the optical information storage medium and detect at least one of an information signal and an error signal; and
a birefringence compensation device arranged to compensate for birefringence on the optical information storage medium, the the birefringence compensation device comprising:
a pair of substrates; and
a liquid crystal layer formed between the substrates and having a phase variation distribution corresponding to a birefringence distribution occurring on the optical information storage medium,
wherein liquid crystal molecules in the liquid crystal layer are vertically aligned when an electric field is not applied thereto, and are radially aligned in axial symmetry when the electric field is applied thereto, and
wherein a phase variation is adjusted according to the magnitude of an applied electric field.

10. The optical pickup as claimed in claim 9, wherein the at least one of the substrates has on an inside thereof an axial symmetric thickness variation profile corresponding to the birefringence distribution occurring on the optical information storage medium.

11. The optical pickup as claimed in claim 10, wherein the thickness variation profile of the at least one of the substrates has a step structure.

12. The optical pickup as claimed in claim 10, wherein the at least one of the substrates is made of a material having the same refractive index as an ordinary refractive index of the liquid crystal or having an index matchable refractive index similar to the ordinary refractive index of the liquid crystal.

13. The optical pickup as claimed in claim 9, wherein the liquid crystal device further comprises an electrode patterned to supply different voltages to different portions of the liquid crystal layer in correspondence with the birefringence distribution occurring on the optical information storage medium.

14. The optical pickup as claimed in claim 9, wherein the liquid crystal device further comprises an alignment film that is formed to vertically align the liquid crystal, and is radially rubbed in axial symmetry.

15. The optical pickup as claimed in claim 14, wherein the alignment film is made using one of polyimide for vertical alignment and SiO deposition.

16. The optical pickup as claimed in claim 9, wherein the liquid crystal has a negative dielectric anisotropic property.

17. The optical pickup as claimed in claim 9, further comprising:
a wave plate arranged to convert polarization of the light incident from the light source,
wherein the birefringence compensation device is positioned between the wave plate and the objective lens.

18. The optical pickup as claimed in claim 17, wherein the wave plate is a quarter-wave plate with respect to a wavelength of the light emitted from the light source so that effective light incident onto the birefringence compensation device is circularly polarized light.

19. An optical recording and/or reproducing apparatus comprising:
an optical pickup installed to move in a radial direction of an optical information storage medium, for reproducing information from and/or recording information onto the optical information storage medium; and
a control unit arranged to control operation of the optical pickup,
wherein the optical pickup is implemented by the optical pickup as claimed in claim 9.

20. The optical recording and/or reproducing apparatus as claimed in claim 19, wherein at least one of the substrates has on an inside thereof an axial symmetric thickness variation profile corresponding to the birefringence distribution occurring on the optical information storage medium.

21. The optical recording and/or reproducing apparatus as claimed in claim 20, wherein the thickness variation profile of the at least one of the substrates has a step structure.

22. The optical recording and/or reproducing apparatus as claimed in claim 20, wherein the at least one of the substrates is made of a material having the same refractive index as an ordinary refractive index of the liquid crystal or having an index-matchable refractive index similar to the ordinary refractive index of the liquid crystal.

23. The optical recording and/or reproducing apparatus as claimed in claim 19, wherein the liquid crystal device further comprises an electrode patterned to supply different voltages to different portions of the liquid crystal layer in correspondence with the birefringence distribution occurring on the optical information storage medium.

24. The optical recording and/or reproducing apparatus as claimed in claim 19, wherein the liquid crystal device further comprises an alignment film that is formed to vertically align the liquid crystal, and is radially rubbed in axial symmetry.

25. The optical recording and/or reproducing apparatus as claimed in claim 24, wherein the alignment film is made using one of polyimide for vertical alignment and SiO deposition.

26. The optical recording and/or reproducing apparatus as claimed in claim 19, wherein the liquid crystal has a negative dielectric anisotropic property.

27. The optical recording and/or reproducing apparatus as claimed in claim 19, wherein the optical pickup further comprises a wave plate for converting polarization of the light incident from the light source, and wherein the birefringence compensation device is positioned between the wave plate and the objective lens.

28. The optical recording and/or reproducing apparatus as claimed in claim 27, wherein the wave plate is a quarter-wave plate with respect to a wavelength of the light emitted from the light source so that effective light incident onto the birefringence compensation device is circularly polarized light.
